(19) United States
(12) Patent Application Publication
(10) Pub. No.: US 2007/0171892 A1
(43) Pub. Date: Jul. 26, 2007

(54) Method and system for supporting special call services in a data network

(76) Inventors: Ilwoo Chang, San Diego, CA (US); Victor Pak, San Diego, CA (US)

Correspondence Address: DITTHAVONG & MORI, P.C., Suite A, 10507 Braddock Road, Fairfax, VA, 22032, US

(21) Appl. No.: 11/408,601

(22) Filed: Apr. 21, 2006

Related U.S. Application Data
(60) Provisional application No. 60/673,454, filed on Apr. 21, 2005.

(51) Int. Cl. H04L 12/66; H04J 1/02

(52) U.S. Cl. 370/352; 370/493

(57) ABSTRACT

An approach is provided for supporting special call services and applications in a data network. A request message is generated for establishment of a voice session over a data network. The request message specifies that the voice session is special as to permit a non-subscriber to establish the voice session for a predetermined duration.

### RELATED APPLICATIONS

This application claims the benefit of the earlier filing date under 35 U.S.C. §119(e) of U.S. Provisional Application Ser. No. 60/673,454 filed Apr. 21, 2005, entitled “Method and System for Supporting Special Call Services in a Data Network,” the entirety of which is incorporated by reference.

### FIELD OF THE INVENTION

Various exemplary embodiments of the invention relate generally to communications.

### BACKGROUND OF THE INVENTION

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. However, not much effort has been placed on deploying telephony services over an Internet Protocol (IP)-based radio access network.

Therefore, there is a need for an approach to support a diversity of communication services over a wireless data network.

### SUMMARY OF SOME EXEMPLARY EMBODIMENTS

These and other needs are addressed by the invention, in which an approach is presented for supporting special call services and applications in a data network.

According to one aspect of an embodiment of the invention, a method comprises generating a request message for establishment of a voice session over a data network. The request message specifies that the voice session is special as to permit a non-subscriber to establish the voice session for a predetermined duration.

According to another aspect of an embodiment of the invention, an apparatus comprises a processor configured to generate a request message for establishment of a voice session over a data network. The request message specifies that the voice session is special as to permit a non-subscriber to establish the voice session for a predetermined duration.

According to another aspect of an embodiment of the invention, a method comprises receiving a request message, from a terminal, for establishment of a voice session over a data network. The request message specifies that the voice session is special as to permit a non-subscriber to establish the voice session for a predetermined duration.

According to yet another aspect of an embodiment of the invention, an apparatus comprises a transceiver configured to receive a request message, from a terminal, for establishment of a voice session over a data network. The request message specifies that the voice session is special as to permit a non-subscriber to establish the voice session for a predetermined duration.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a wireless system including an Access Network (AN) and an Access Terminal (AT) configured to support special call services and applications, in accordance with an embodiment of the invention;

FIG. 2 is a flowchart of a process for exchanging signalling to establish a special session, in accordance with an embodiment of the invention;

FIG. 3 is a diagram an AN and an AT utilizing session layer messages to establish a special session, in accordance with an embodiment of the invention;

FIG. 4 is a diagram of an exemplary format of a request message for establishment of a special voice call, in accordance with an embodiment of the invention;

FIG. 5 is a diagram of an exemplary format of an assignment message for establishment of a special voice call, in accordance with an embodiment of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for supporting special call services and applications in a data network. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the invention.

Although the invention is discussed with respect to a radio communication network (such as a cellular system), it is recognized by one of ordinary skill in the art that the invention has applicability to any type of communication systems, including wired systems. Additionally, the various embodiments of the invention are described with respect to an 1× Evolutionfor Data Only (1×EV-DO) system, it is recognized by one of ordinary skill in the art that the invention has applicability to other equivalent communication systems.

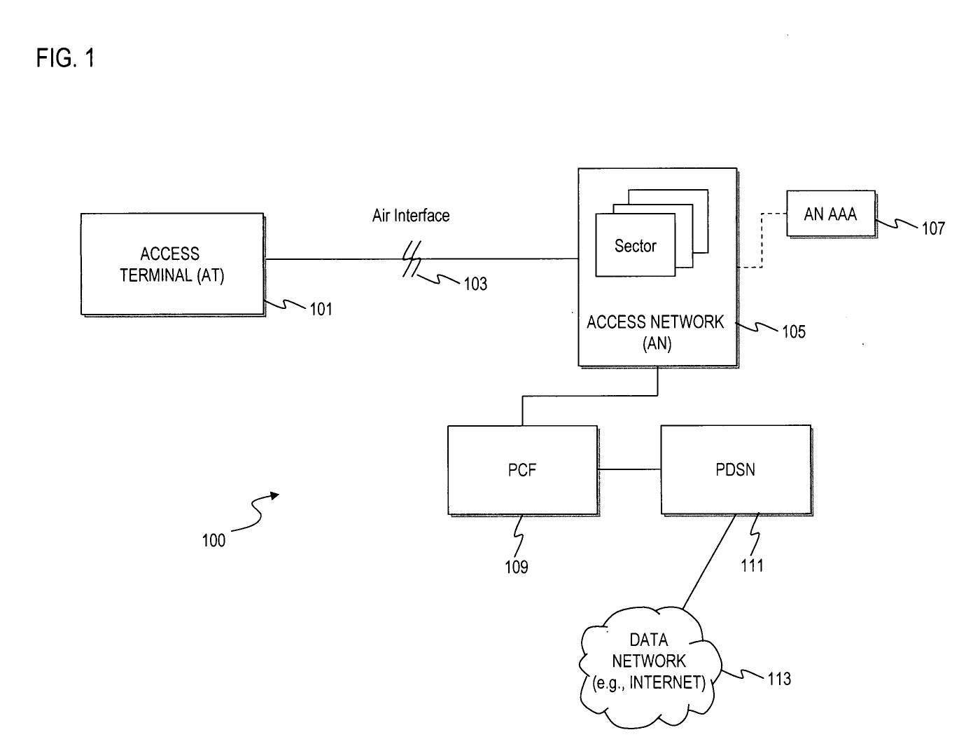

FIG. 1 is a diagram of the architecture of a wireless system including an Access Network (AN) and an Access Terminal (AT) configured to support special call services and applications, in accordance with an embodiment of the invention. By way of example, a radio network 100 operates according to the Third Generation Partnership Project 2 (3GPP2) standard for supporting High Rate Packet Data (HRPD). A more detailed description of the HRPD is provided in 3GPP2 C.S0024 v3.0, entitled “cdma2000 High Rate Packet Data Air Interface Specification,” December 2001, 3GPP2 A.S0007-A v2.0, entitled “Interoperability Specification (IOS) for High Rate Packet Data (HRPD) Access Network Interfaces—Rev. A,” May 2003, and 3GPP2 A.S0008-0 v3.0, entitled “Interoperability Specification (IOS) for High Rate Packet Data (HRPD) Access Network Interfaces,” May 2003; which are incorporated herein by reference in their entireties. The radio network 100 includes one or more access terminals (ATs) 101 of which one AT 101 is shown in communication with an access network (AN) 105 over an air interface 103. The AT 101 is a device that provides data connectivity to a user. The terminal 101, in one embodiment, can be a mobile. As used herein, the terms “mobile,” “mobile station,” “mobile device” or “unit” are synonymous. For example, the AT 101 can be connected to a computing system, such as a personal computer, a personal digital assistant, and etc. or a data service enabled cellular handset.

The AN 105 is a network equipment that provides data connectivity between a packet switched data network, such as the global Internet 113 and the AT 101. In cdma2000 systems, the AT 101 is equivalent to a mobile station, and the access network is equivalent to a base station.

The AN 105 communicates with a Packet Data Service Node (PDSN) 111 via a Packet Control Function (PCF) 109. Either the AN 105 or the PCF 109 provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety.

In addition, the AN 105 communicates with an AN-AAA (Authentication, Authorization and Accounting entity) 107, which provides terminal authentication and authorization functions for the AN 105.

Both the CDMA2000 1×EV-DV (Evolutionary/Data and Voice) and 1X EV-DO (Evolutionary/Data Only) air interface standards specify a packet data channel for use in transporting packets of data over the air interface on the forward link and the reverse link. A wireless communication system may be designed to provide various types of services. These services may include point-to-point services, or dedicated services such as voice and packet data, whereby data is transmitted from a transmission source (e.g., a base station) to a specific recipient terminal. These services may also include point-to-multipoint (i.e., multicast) services, or broadcast services, whereby data is transmitted from a transmission source to a number of recipient terminals.

In the 1× Evolutionfor Data Only (1×EV-DO) system, Voice over IP (VoIP) services, or packetized voice services, are supported with enhanced Medium Access Control (MAC) layer protocols. Traditionally, the 1×EV-DO system supports only the packet data-oriented services, therefore there is no concept of special call services. By contrast, the invention, according to one embodiment, supports an emergency call service using VoIP in the HRPD system. It is recognized, however, that the approach is not limited to an emergency call service, but has applicability to any other service provider services—e.g., 611 or Mobile Virtual Network Operator (MVNO).

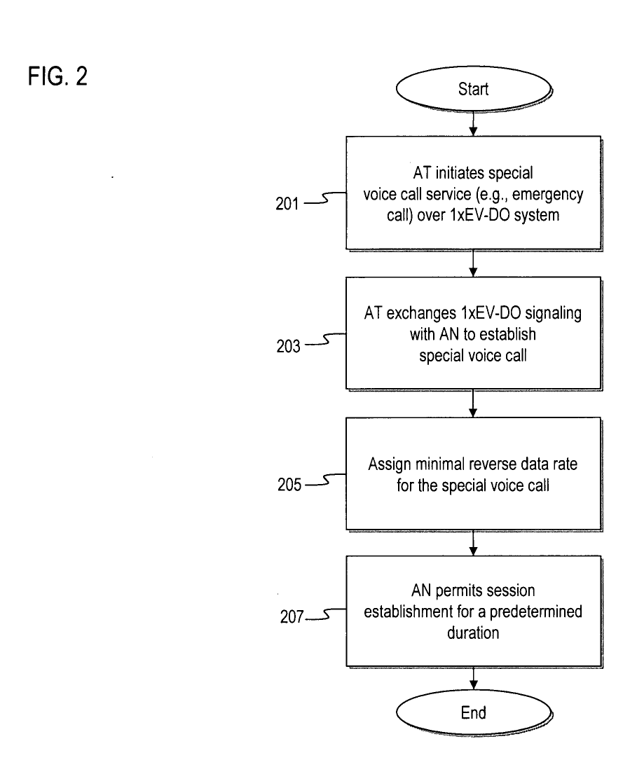

Conventionally, before transmitting upper layer packets, the terminal 101 and the network 105 would require various signaling procedures. For example, after assignment of a Unique Access Terminal Identifier (UATI), the terminal 101 set ups a 1×EV-DO traffic channel and all the protocols of the 1×EV-DO needed to negotiate individual attributes. This approach can be very expensive in terms of network resource usage and processing delay. The process of FIG. 2 addresses these drawbacks.

FIG. 2 is a flowchart of a process for exchanging signalling to establish a special session, in accordance with an embodiment of the invention. In case of special services call (e.g., emergency call), a few challenges are recognized. First, the system 100 should permit a terminal (e.g., terminal 101) to access the network 105 under certain special circumstances, such as an emergency, even if the terminal 101 is not a valid subscriber. Second, session negotiation should be skipped or bypassed, wherein the terminal 101 and the network 105 should be able to exchange the upper layer packets (e.g., voice packets) as soon as possible. Third, the network 101 should not allow any terminal to abuse the emergency call service mechanism for normal packet transmissions.

As seen in FIG. 2, to address the first challenge, the terminal 101 can initiate the emergency call using, for example, appropriate HRPD signaling (per step 201). The network 105 allows the 1×EV-DO service for this terminal 101, even if the terminal 101 is not a valid subscriber. Thereafter, both the terminal 101 and the network 105 configure a special voice session (e.g., “emergency call” session). This session employs all the protocols required to support VoIP over the air interface 103, as in step 203. Therefore, the terminal 101 and the network 105 need not undergo the standard session configuration.

According to one embodiment of the invention, during an emergency call, the terminal 101 can send, as in step 205, a minimum Data Rate Control (DRC) (e.g., 38.4 kbps). Also, the network 105 ensures that the reverse data rate is only sufficient to support the packetized voice session (e.g., VoIP call) of minimal quality by sending UnicastReverseRateLimit message (in case of subtype 0 and 1 Reverse Traffic Channel (RTC) MAC Protocol) or assigning minimum Traffic-to-Pilot (T2P) (in case of subtype 2 and 3 RTC MAC Protocol). These mechanisms ensure that the emergency service is not abused for the normal packet service, in that only very low data throughput Oust enough for a VoIP call of minimally acceptable quality) is used. Further, the assigned UATI can be set to expire based on a predetermined duration, as in step 207. This ensures that the emergency service session will expire after reasonable time.

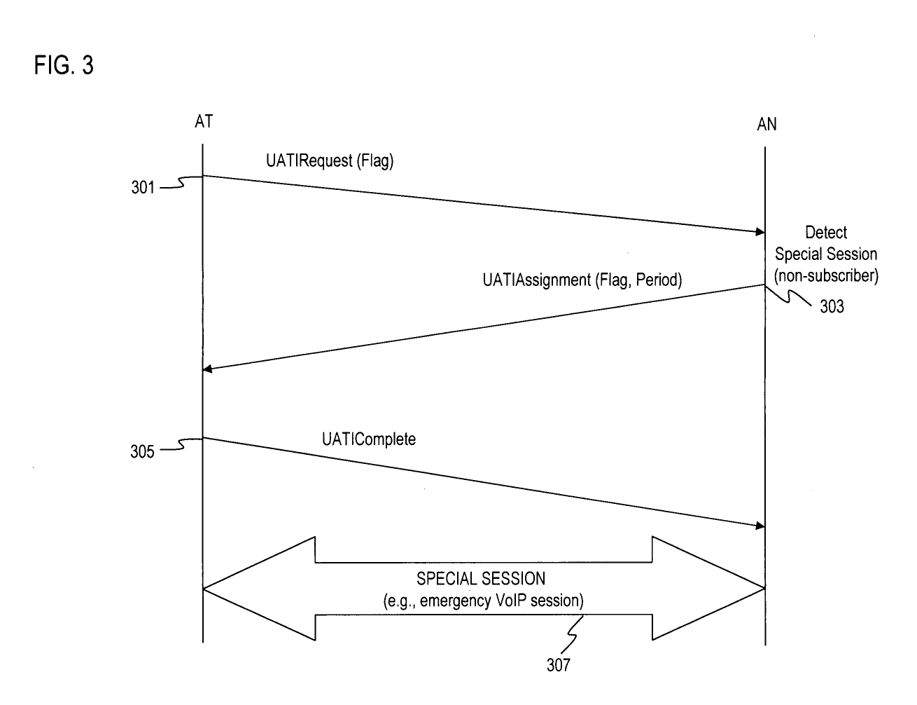

Details of the establishment of the special voice session is described with respect to FIG. 3.

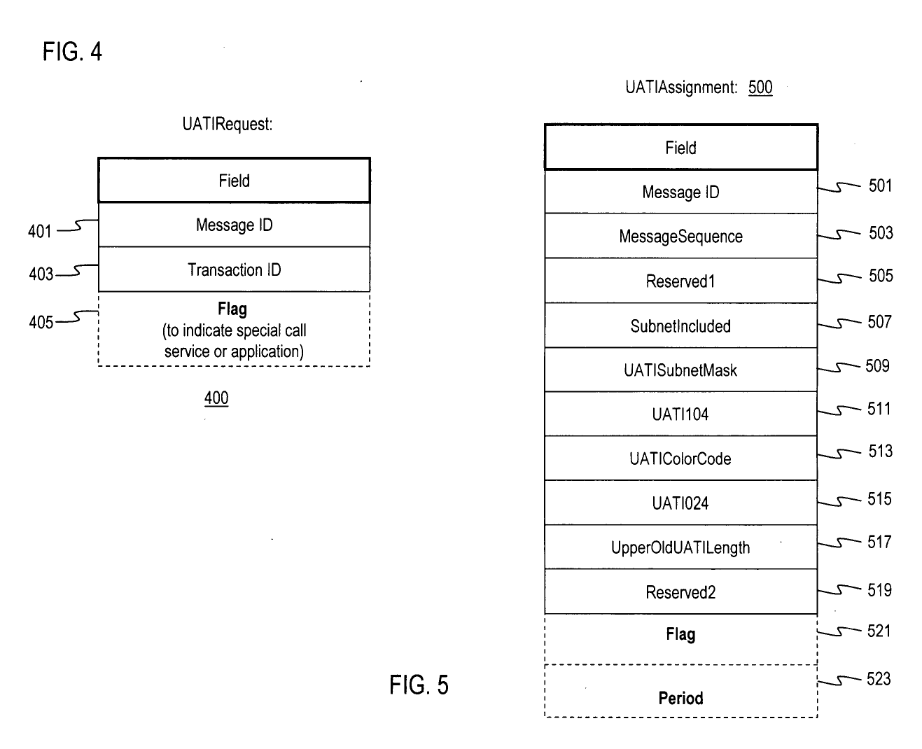

FIG. 3 is a diagram an AN and an AT utilizing session layer messages to establish a special session, in accordance with an embodiment of the invention. The terminal 101 first sends HRPD signalling messages to the network 105 at the time of the emergency call. Specifically, the terminal 101 generates a request message—e.g., UATIRequest message; the format of this message is shown in FIG. 4. In an exemplary embodiment, the UATIRequest message (FIG. 4) includes a special flag to indicate that a special services call (e.g., emergency) or special session is being initiated. Such message is a modified UATIRequest message from existing HRPD standards. In step 301, the terminal 101 transmits the request message (e.g., UATIRequest message) to the access network 105. Consequently, when the terminal 101 sends the UATIRequest message with the special flag set, for example, for an emergency call, the network 105 can be notified that special handling is being requested.

FIG. 4 is a diagram of an exemplary format of a request message for establishment of a special voice call, in accordance with an embodiment of the invention. A UATIRequest message 400 includes a MessageID (message identifier) field 401, and a TransactionID (transaction identifier) field 403. Additionally, a Flag field 405 is provided to indicate the special session or application (e.g., emergency call). It is contemplated that this mechanism in addition to emergency calls can be used for other services, such 611 call or MVNO.

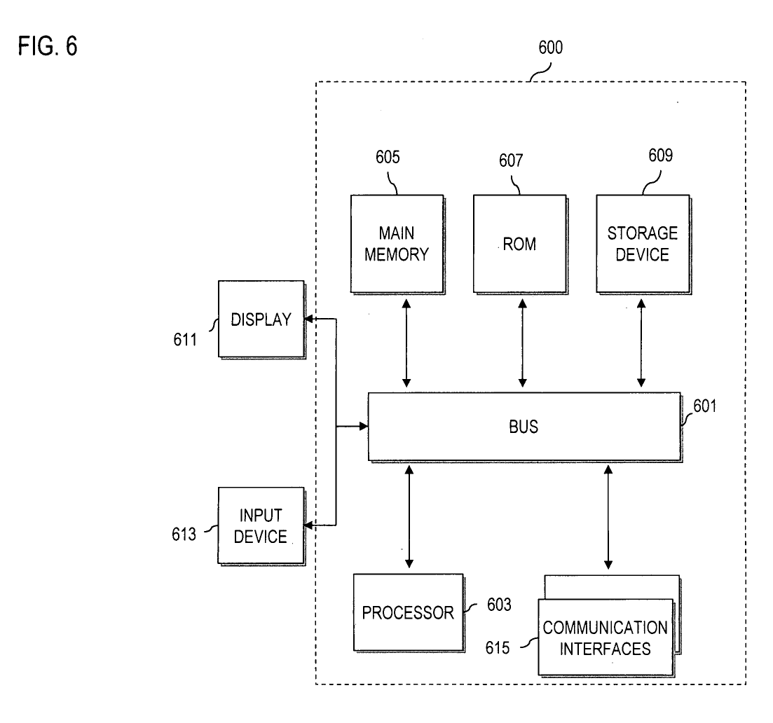

Continuing with the example of FIG. 3, once the AN 105 receives this message, the AN 105 accepts the AT 101 even if the AT 101 is a non-subscriber. The AN 105 checks the request message for the flag setting. If the setting indicates a special services call, the AN 105 assigns an UATI and sends, per step 303, an assignment message, such as a UATIAssignment message (which is illustrated in FIG. 5).

FIG. 5 is a diagram of an exemplary format of an assignment message for establishment of a special voice call, in accordance with an embodiment of the invention. The assignment message, e.g., UATIAssignment, assigns the UATI to the terminal 101. Further, the assignment message indicates that the voice session (e.g., voice call) is special, and specifies effectively the duration of the voice session. Table 1 below describes the fields of the assignment message 500 of FIG. 5:

TABLE 1

| Field | Description |
|---|---|
| MessageID 501 | Specifies type of message; AN 105 can |
| | set this field to 0x01. |
| MessageSequence 503 | AN 105 can set this field to 1 higher |
| | than the MessageSequence field of the |
| | last UATIAssignment message (modulo |
| | 256) that it has sent to the AT 101. |
| Reserved1 505 | AT 101 ignores this field. |
| SubnetIncluded 507 | AN 105 can set to “1” if the |
| | UATI104 field and UATISubnetMask |
| | field are included. |
| UATISubnetMask 509 | AN 105 omits this field if |
| | SubnetIncluded is set to “0.” |
| | If included, the AN 105 sets the |
| | field to the number of consecutive |
| | 1's in the subnet mask of the subnet |
| | to which the assigned UATI belongs. |
| UATI104 513 | AN 105 omits this field if |
| | SubnetIncluded is set to “0.” |
| | If included, AN 105 sets this to |
| | UATI[127:24] of the UATI that |
| | it is assigning to the AT 101. |
| UATIColorCode 515 | AN 105 sets this field to the Color |
| | Code associated with the subnet to |
| | which the UATI belongs. |
| UATI024 517 | AN 105 set this field to |
| | UATI[23:0] of the UATI that it |
| | is assigning to the AT 101. |
| UpperOldUATILength 519 | AN 105 sets this field to the number |
| | of least significant octets of |
| | OldUATI[127:24] that the |
| | AT 101 is to send in the UATIComplete |
| | message. |
| Reserved2 519 | AT 101 ignores this field. |
| Flag 521 | Set to specify special services call |
| | (e.g., emergency voice call). |
| Period 523 | Indicates the time period (or life) |
| | of UATI (i.e., duration of the voice |
| | session). |

As seen in FIG. 5, the UATIAssignment includes two additional fields over the standard UATIAssignment message: Flag field 521 and Period field 523. The Flag field 521 indicates the purpose of the message, and can be set to indicate an emergency call (or special session). The Period field 523 indicates the time period (or life) of UATI. For example, the AN 105 can set the Period to 30 minutes, 1 hour, or any configurable time; this forces the emergency session to expire after the specified time period, thereby preventing potential abuse by terminal 101.

Once UATIAssignment is sent to the AT 101, the AN 105 can generate pseudo-IMSI (International Mobile Subscriber ID). Upon receiving the emergency call UATI, the AT 101 generates a complete message to acknowledge receipt of the assignment message. The complete message, e.g., UATIComplete message, is transmitted to the AN 105, per step 305. When the AN 105 receives the UATIComplete message, both the AT 101 and the AN 105 can set up the voice session (e.g, pre-defined emergency call), as in step 307. By way of example, Table 2 enumerates fields of the complete message, such as UATIComplete message:

TABLE 2

| Field | Description |
|---|---|
| MessageID | Specifies type of message; AN 105 can set this |
| | field to 0x02. |
| MessageSequence | AT 101 can set this field to the MessageSequence |
| | field of the UATIAssignment message whose |
| | receipt this message is acknowledging. |
| Reserved | AN 105 ignores this field. |
| UpperOldUATILength | AT 101 sets this field to the length of the |
| | UpperOldUATI field in octets. |
| UpperOldUATI | If UpperOldUATILength in the UATIAssignment |
| | message whose receipt this message is |
| | acknowledging is not zero, and OldUATI is not |
| | NULL, the AT 101 can set this field to |
| | OldUATI[23+ UpperOldUATILength×8:24]. |
| | Otherwise, the AT 101 omits this field. |

When the UATI time period expires (for example, after 30 minutes), both the terminal 101 and network 105 remove or teardown the emergency session. In one embodiment, if the terminal 101 still needs the emergency session, the terminal 101 can re-send the UATIRequest message with the special flag. As mentioned, the time period can be appropriately set to avoid the terminal 101 having to re-send in an emergency situation.

In an exemplary embodiment, if either the terminal 101 or the network 105 is 1×EV-DO Rev.0, then one example of the emergency call session may be the default packet application on the stream 1. According to another embodiment, in case both the terminal 101 and the network 105 support the 1×EV-DO Rev A, then the pre-defined emergency call session may be the multi-flow packet application on the stream 1 and the reverse traffic channel MAC protocol Subtype 3. One Radio Link Protocol (RLP) flow and two MAC flows may be activated and associated with each other. All the attributes can be set up to the pre-defined value that is optimal for the packetized voice session (e.g., VoIP call).

In an exemplary embodiment, once the connection is set up for VoIP packets, the terminal 101 can send the minimum data rate control (DRC) value (e.g., 38.4 kbps) to support VoIP packet transmission. Also, according to one embodiment of the invention, in order to limit reverse data rate, the network 105 can send a control message, such as a UnicastReverseRateLimit message (in case of subtype 0 and 1 RTC MAC protocols) or Grant message (in case of subtype 2 and 3 RTC MAC protocols). That is, the AN 105 uses the UnicastReverseRateLimit message to control the transmission rate of the reverse link for a particular access terminal 105. The MAC protocols are more fully described in 3GPP2 C.S0024-A v. 10, entitled “cdma2000 High Rate Packet Data Air Interface Specification,” March 2004, which is incorporated herein by reference in its entirety.

Based on the above mechanism, the radio system 100 (of FIG. 1) can provide an emergency call service in a simple and flexible manner. By employing a Flag field 405 in the UATIRequest message 400, the terminal 101 can notify to the network 105 of the kinds of applications or services the terminal 101 seeks during the communication session. Such applications or services can include service provider specific services, such as 611 or MVNO (mobile virtual network operator).

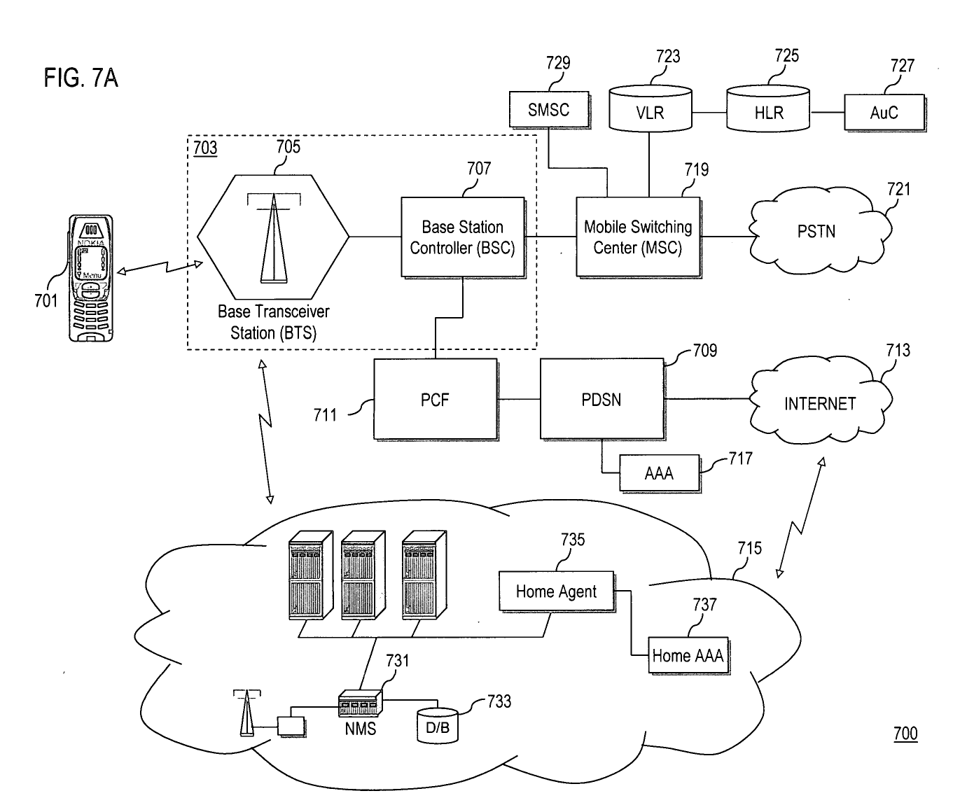

One of ordinary skill in the art would recognize that the processes for providing special call services and applications may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

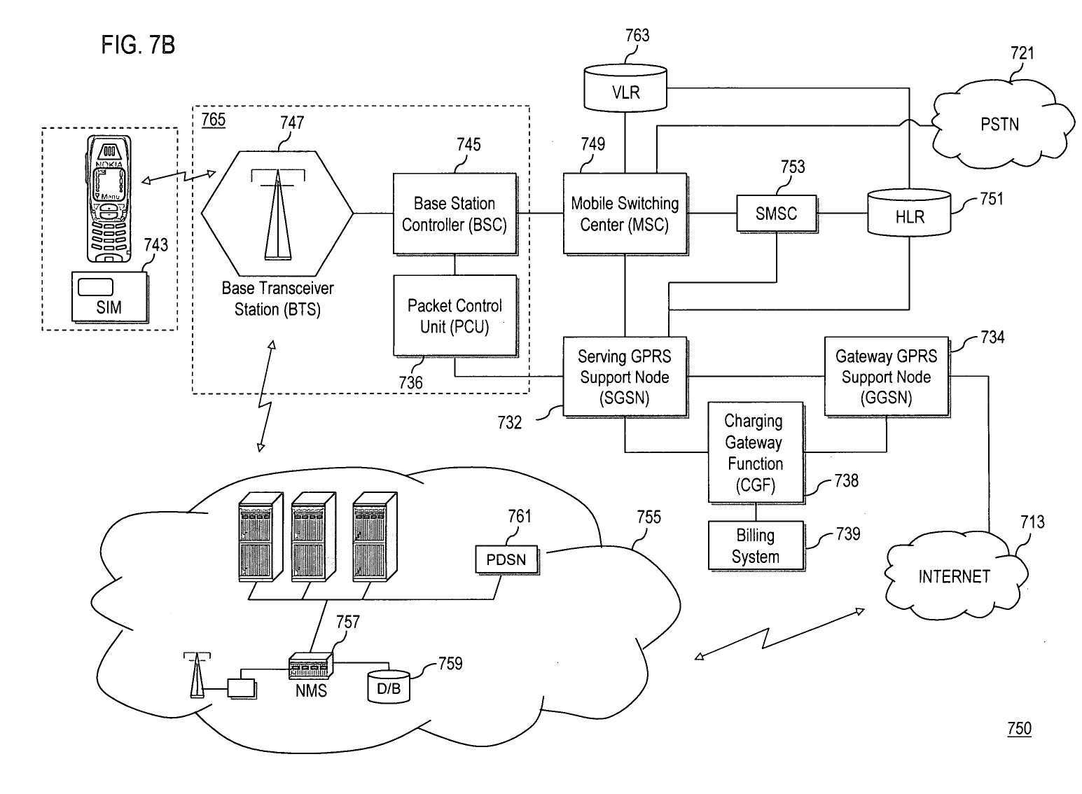

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit PCU (1336) and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 731 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 733 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

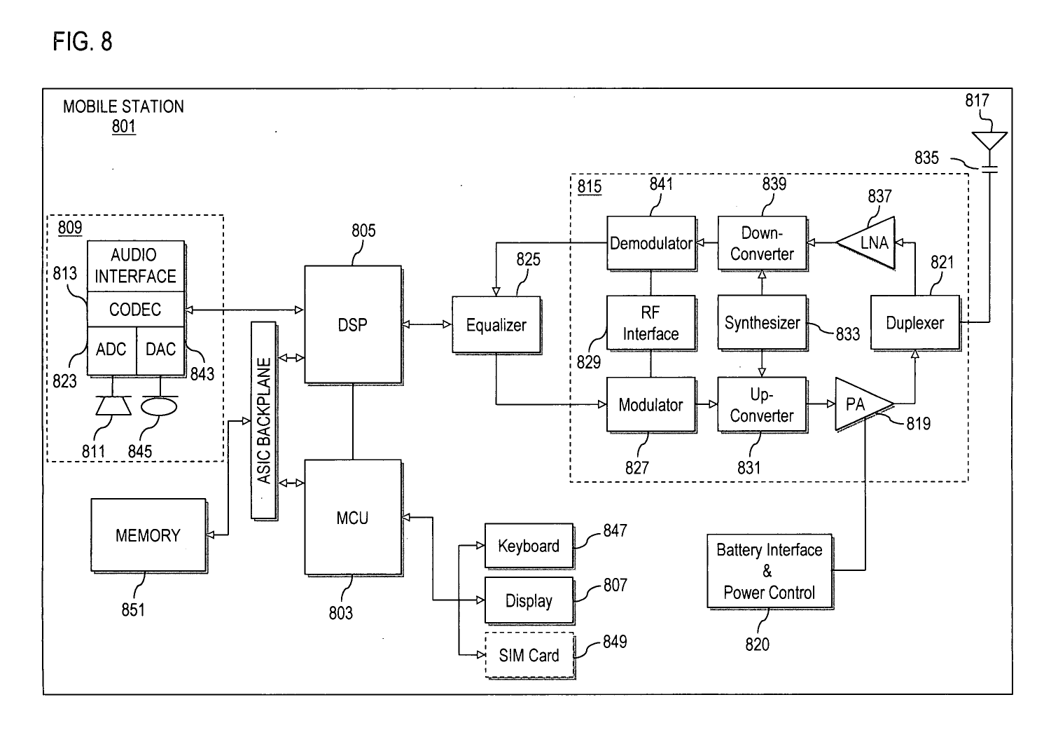

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 1005. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

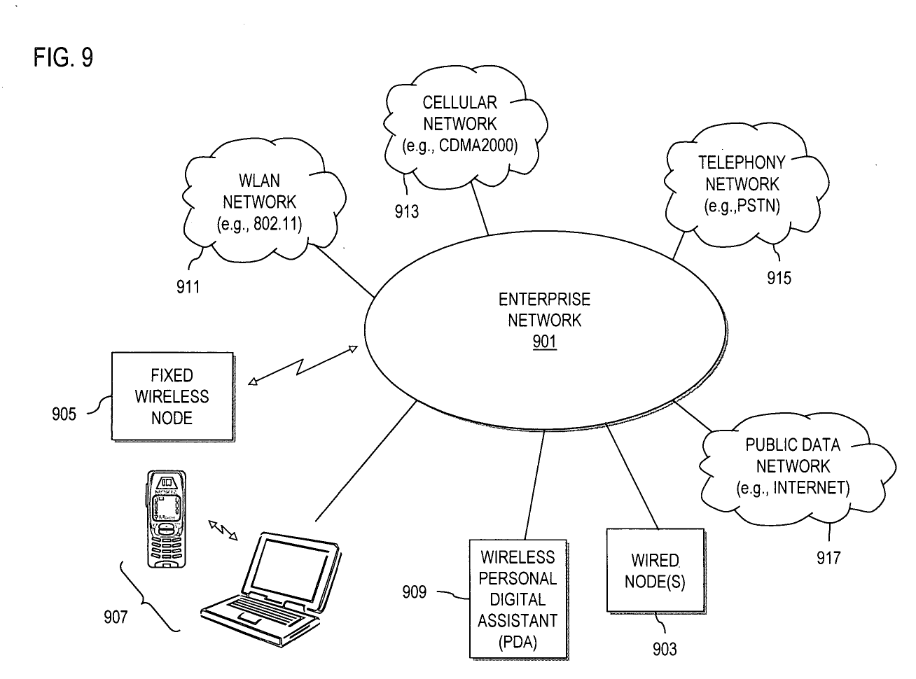

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 916 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
generating a request message for establishment of a voice session over a data network,
wherein the request message specifies that the voice session is special as to permit a non-subscriber to establish the voice session for a predetermined duration.

2. A method according to claim 1, wherein the data network includes a cellular network, and the voice session is a Voice over Internet Protocol (VoIP) call.

3. A method according to claim 1, wherein the request message includes,
a field for specifying a message identifier,
a field for specifying a transaction identifier, and
a field for indicating that the voice session is special.

4. A method according to claim 1, further comprising:
transmitting the request message to the data network; and
receiving an assignment message from the data network, wherein the assignment message assigns a terminal identifier for communicating over the data network.

5. A method according to claim 4, wherein the assignment message includes,
a field for specifying a message identifier,
a field for specifying the terminal identifier,
a field for indicating that the voice session is special, and
a field for specifying the predetermined duration.

6. A method according to claim 4, further comprising:
generating a complete message to acknowledge receipt of the assignment message.

7. A method according to claim 1, wherein normal session negotiation for the establishment of the voice session is bypassed by the data network upon determining that the voice session is special.

8. A method according to claim 1, wherein data rate of a reverse channel associated with the special voice session is limited by a predetermined value.

9. A method according to claim 1, wherein the special voice session is an emergency call.

10. An apparatus comprising:
a processor configured to generate a request message for establishment of a voice session over a data network,
wherein the request message specifies that the voice session is special as to permit a non-subscriber to establish the voice session for a predetermined duration.

11. An apparatus according to claim 10, wherein the data network includes a cellular network, and the voice session is a Voice over Internet Protocol (VoIP) call.

12. An apparatus according to claim 10, wherein the request message includes,
a field for specifying a message identifier,
a field for specifying a transaction identifier, and
a field for indicating that the voice session is special.

13. An apparatus according to claim 10, further comprising:
a transceiver configured to transmit the request message to the data network, wherein the transceiver is further configured to receive an assignment message from the data network, the assignment message assigning a terminal identifier for communicating over the data network.

14. An apparatus according to claim 13, wherein the assignment message includes,
a field for specifying a message identifier,
a field for specifying the terminal identifier,
a field for indicating that the voice session is special, and
a field for specifying the predetermined duration.

15. An apparatus according to claim 13, wherein the processor is further configured to generate a complete message to acknowledge receipt of the assignment message.

16. An apparatus according to claim 10, wherein normal session negotiation for the establishment of the voice session is bypassed by the data network upon determining that the voice session is special.

17. An apparatus according to claim 10, wherein data rate of a reverse channel associated with the special voice session is limited by a predetermined value.

18. An apparatus according to claim 10, wherein the special voice session is an emergency call.

19. A system comprising the apparatus of claim 10, the system comprising:
a keyboard configured to receive input from a user to initiate the special voice session; and
a display configured to display the input.

20. A method comprising:
receiving a request message, from a terminal, for establishment of a voice session over a data network,
wherein the request message specifies that the voice session is special as to permit a non-subscriber to establish the voice session for a predetermined duration.

21. A method according to claim 20, wherein the data network includes a cellular network, and the voice session is a Voice over Internet Protocol (VoIP) call.

22. A method according to claim 20, wherein the request message includes,
a field for specifying a message identifier,
a field for specifying a transaction identifier, and
a field for indicating that the voice session is special.

23. A method according to claim 20, further comprising:
generating an assignment message in response to the request message, wherein the assignment message assigns a terminal identifier for communicating over the data network; and
transmitting the assignment message to the terminal.

24. A method according to claim 23, wherein the assignment message includes,
a field for specifying a message identifier,
a field for specifying the terminal identifier,
a field for indicating that the voice session is special, and
a field for specifying the predetermined duration.

25. A method according to claim 23, further comprising:
receiving a complete message acknowledging receipt of the assignment message.

26. A method according to claim 20, wherein normal session negotiation with the terminal for the establishment of the special voice session is bypassed.

27. A method according to claim 20, wherein data rate of a reverse channel associated with the special voice session is limited by a predetermined value.

28. A method according to claim 20, wherein the special voice session is an emergency call.

29. An apparatus comprising:
a transceiver configured to receive a request message, from a terminal, for establishment of a voice session over a data network,
wherein the request message specifies that the voice session is special as to permit a non-subscriber to establish the voice session for a predetermined duration.

30. An apparatus according to claim 29, wherein the data network includes a cellular network, and the voice session is a Voice over Internet Protocol (VoIP) call.

31. An apparatus according to claim 29, wherein the request message includes,
a field for specifying a message identifier,
a field for specifying a transaction identifier, and
a field for indicating that the voice session is special.

32. An apparatus according to claim 29, further comprising:
means for generating an assignment message for transmission to the terminal in response to the request message, wherein the assignment message assigns a terminal identifier for communicating over the data network.

33. An apparatus according to claim 32, wherein the assignment message includes,
a field for specifying a message identifier,
a field for specifying the terminal identifier,
a field for indicating that the voice session is special, and
a field for specifying the predetermined duration.

34. An apparatus according to claim 32, wherein the transceiver is further configured to receive a complete message acknowledging receipt of the assignment message.

35. An apparatus according to claim 29, wherein normal session negotiation with the terminal for the establishment of the special voice session is bypassed.

36. An apparatus according to claim 29, wherein data rate of a reverse channel associated with the special voice session is limited by a predetermined value.

37. An apparatus according to claim 29, wherein the special voice session is an emergency call.

38. A system comprising the apparatus of claim 29.
